(19) United States
(12) Patent Application Publication
(10) Pub. No.: US 2022/0335481 A1
(43) Pub. Date: Oct. 20, 2022

(54) CROWDSOURCED FUNDING ENGINE

(71) Applicant: Adaptation Financial Advisors, Oklahoma City, OK (US)

(72) Inventor: Alan P. Niemann, Oklahoma City, OK (US)

(21) Appl. No.: 17/722,589

(22) Filed: Apr. 18, 2022

Related U.S. Application Data
(60) Provisional application No. 63/176,678, filed on Apr. 19, 2021.

(51) Int. Cl. G06Q 30/02; G06Q 40/06; G06Q 40/02

(52) U.S. Cl. CPC G06Q 30/0279; G06Q 40/06; G06Q 40/02

(57) ABSTRACT

Computer-implemented systems, methods and storage devices for crowdsourcing to enable a funding amount to be distributed to one the one or more custodial accounts of a beneficiary. A portfolio funding manager is configured to enable a user to select a funding amount, distribute the selected funding amount among the one or more custodial accounts of the beneficiary in transactions, and generate documents or messages associated with the respective transactions. The portfolio funding manager may generate a link that enables users to make deposits into one or more custodial accounts of the beneficiary. The portfolio funding manager enables the beneficiary to send messages having the generated link to other users. Display views may include a dashboard view, a view of account detail, a view that enables addition of funds, a view that enables viewing of documents, and a view that enables a donation link to be sent to friends and family.

### CROSS-REFERENCE TO RELATED APPLICATIONS

This application is a non-provisional application and claims the benefit of U.S. provisional application no. 63/176,678, filed Apr. 19, 2021, incorporated in its entirety herein by reference.

### BACKGROUND

### Technical Field

The field relates to computer-implemented electronic transactions and user-interface functionality.

### Background

Computer networks increasingly support electronic transactions in a variety of industries. Applications now allow user to carry out basic electronic banking functions. These may include allowing a user to view and make deposits through a website or on a mobile application into his or her account. This may include a checking, loan or savings account. Other applications allow limited transactions for a user to view retirement account status and activity. For example, some financial services companies such as Charles Schwab at www.schwab.com allow a user to log in and access a dashboard or other display view to view and print account summary information regarding his or her 401K or IRA accounts or other brokerage accounts in a display view. For security and other reasons, access and electronic transactions are limited to those involving a user's personal account only. Electronic transactions such as making a deposit may occur only with respect to a person's own account.

Recently, a number of minors rely on custodial accounts to accrue funds for college education, saving, or other needs. Minors especially rely on other people such as parents or guardians for contributions.

### BRIEF SUMMARY

The present disclosure overcomes the above deficiencies and technical problems. The present disclosure provides new computer-implemented systems, methods and storage devices for crowdsourcing to enable a funding amount to be distributed to one the one or more custodial accounts of a beneficiary.

In an embodiment, a crowdsourced funding system is configured to communicate over a network with applications on remote devices accessed by users wishing to donate to a beneficiary having one or more custodial accounts. The system includes a controller and a portfolio funding manager coupled to the controller. The portfolio funding manager is configured to enable a user to select a funding amount, distribute the selected funding amount among the one or more custodial accounts of the beneficiary in respective transactions, and generate one or more documents or messages associated with the respective transactions.

In a further feature, the portfolio funding manager is further configured to generate a link that enables users to make deposits into one or more custodial accounts of the beneficiary. The portfolio funding manager enables the beneficiary to send messages having the generated link to other users. For example, the other users may be friends and family of the beneficiary.

In an embodiment, the portfolio funding manager may enable the user to select a funding amount including outputting one or more display views that enable the user to choose a funding method and enter a deposit amount. The portfolio funding manager may communicate with a second user in response to the second user having selected the generated link and enable the second user to select a funding amount. The portfolio funding manager may output one or more display views that enable the second user to enter a deposit amount.

In a further embodiment, the portfolio funding manager is configured to output one or more of the following display views: a dashboard view, a view of account detail, a view that enables addition of funds, a view that enables viewing of documents, a view that enables management of a user profile, a view to enable contact with a financial advisor, and a view that enables a donation link to be sent to friends and family.

In still further examples, the portfolio funding manager may be further configured to determine whether a custodial account for college savings has reached a maximum limit according to predetermined rules, and to allocate the selected funding amount up to the maximum limit for the custodial account for college savings. The portfolio funding manager may be also further configured to allocate the selected funding amount among the one or more custodial accounts according to predetermined critera. The criteria may include giving priority to one or more custodial accounts for college savings up to maximum limits according to predetermined rules, and allocating remaining portions of the selected funding amount to other custodial accounts relating to one or more of life insurance, savings, UMTA, donor advised fund, or an IRA.

In a further embodiment, the portfolio funding manager is configured to generate documents for disclosure or signature according to predetermined rules, and is configured to evaluate the selected funding amount according to predetermined rules.

Computer-implemented methods and storage devices for crowdsourced funding over a network with applications on remote devices accessed by users wishing to donate to a beneficiary having one or more custodial accounts are also provided.

Further embodiments, features, and advantages of the invention, as well as the structure and operation of the various embodiments of the invention are described in detail below with reference to accompanying drawings.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a diagram of a crowdsourced funding system according to an embodiment of the present invention.

FIG. 2 is a flowchart diagram of a method for crowdsourced funding of a custodial account over a network according to an embodiment of the present invention.

FIG. 3 is a flowchart diagram of shareable link generation according to an embodiment of the present invention.

FIGS. 4-17 are images of display views that may appear in applications on display screens of mobile computing devices according to embodiments.

### DETAILED DESCRIPTION

Embodiments of the present invention overcome the above-mentioned disadvantages. The inventor(s) recognized what is needed are systems and methods for crowdsourced funding of custodial accounts over a network.

Embodiments refer to illustrations described herein with reference to particular applications. It should be understood that the invention is not limited to the embodiments. Those skilled in the art with access to the teachings provided herein will recognize additional modifications, applications, and embodiments within the scope thereof and additional fields in which the embodiments would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Crowdsourced Funding System

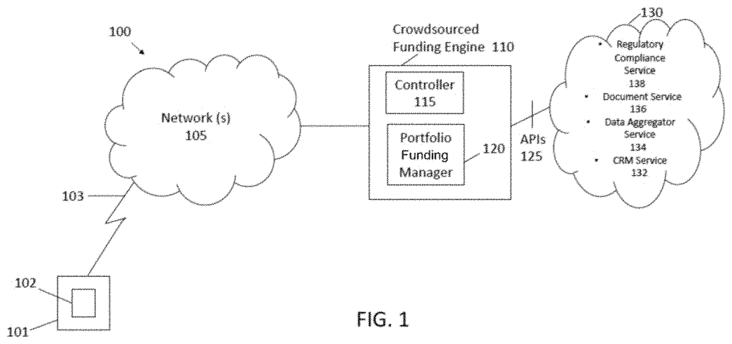

FIG. 1 shows a crowdsourced funding system 100 according to an embodiment of the present invention. In one feature, crowdsourced funding system 100 enables a funding amount to be distributed to one the one or more custodial accounts of a beneficiary. System 100 includes a crowdsourced funding engine 110 having a controller 115 and a portfolio funding manager 120 coupled to controller 115. Crowdsourced funding engine 110 is configured to communicate over one or more networks 105 with one or more applications 102 that operate on remote devices 101.

One or more applications 102 may be provided on remote computing devices 101 operated by the users. Remote computing device 101 may include, but is not limited to, a personal computer, desktop, laptop or tablet computer, mobile phone, workstation, smart television, game console, set-top box, kiosk, wearable computing device (such as a smart watch), embedded device, or other computing device having a processor and memory and capable of supporting a browser and/or operating system. Applications 102 may be web applications accessed with browsers on the computing devices 101 or stand alone applications running on the computing devices 101 in coordination with an operating system. Each computing device 101 can run a respective application 102 to access crowdsourced funding engine 110. Each application 102 may be communicatively coupled to crowdsourced funding engine 110 over the World Wide Web using web protocols and web servers. Network 105 may be any data network or combination of data networks including but not limited to the Internet.

Crowdsourced funding engine 110 is further configured to communicate with one or more computer-implemented services 130 as part of a cloud-based platform. In one embodiment, services 130 may include a customer relationship management (CRM) service 132, data aggregator service 134, document management service 136, and a regulatory compliance service 138. In one example, crowdsourced funding engine 110 may be implemented to communicate with and pass data to and from services 130 through one or more application programming interfaces (APIs) 125. Controller 115 may assist in control of operations within engine 110 including coordination of tasks and communication between portfolio funding manager 120 and one or more applications 102 and cloud services 130.

In embodiments, crowdsourced funding engine 110 and each of its components (controller 115 and portfolio manager 120) may be implemented in software, firmware, hardware or any combination thereof and may be implemented on one or more computing devices at the same or different locations. System 100 including crowdsourced funding engine 110 and its components (controller 115 and portfolio funding manager 120) and services 130 may be implemented in a computer-implemented platform such as a cloud-based, Software as a Service (Saas) and/or Infrastructure as a Service (Iaas) platform having one more servers and/or Web servers.

In an embodiment, portfolio funding manager 120 (also referred to as portfolio donation manager) enables a user to select a funding amount, distribute the selected funding amount among the one or more custodial accounts of the beneficiary in respective transactions, and generate one or more documents or messages associated with the respective transactions. In a further feature, portfolio funding manager 120 may generate a link that enables users to make deposits into one or more custodial accounts of the beneficiary. Portfolio funding manager 120 enables the beneficiary to send messages having the generated link to other users. For example, the other users may be friends and family of the beneficiary. For example, messages may be sent as text messages or electronic mail messages. Users may select the generated link and access one or more display views in an application 102 on their respective device 101. For example, a display view may include user interface elements such as a template, drop down menu, text box, slider, or other input to allow a user to make a deposit. In this way, remote users may easily use respective application 102 on computing devices 101 to make deposits to custodial accounts of a desired beneficiary.

Further portfolio funding manager 120 may output data to allow application 102 to display other display views to a user including one or more of the following display views: a dashboard view, a view of account detail, a view that enables addition of funds, a view that enables viewing of documents, a view that enables management of a user profile, a view to enable contact with a financial advisor, and a view that enables a donation link to be sent to friends and family.

### Operation

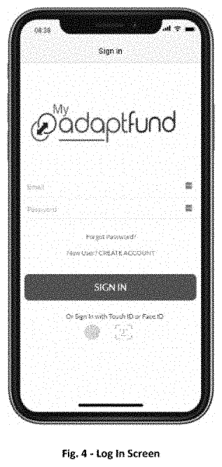

The operation of system 100 is described in further detail below with respect to methods 200 and 300, and example display views in FIGS. 4-17.

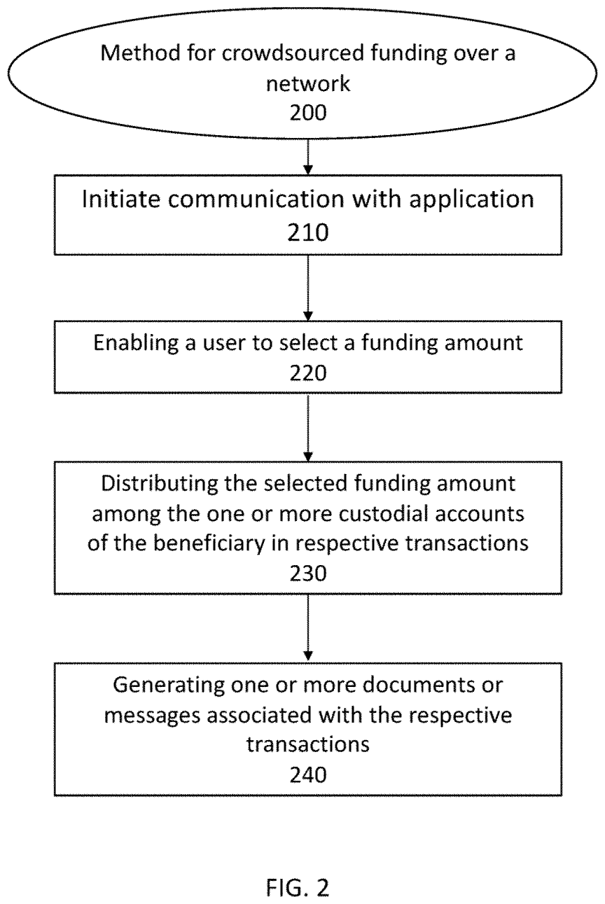

FIG. 2 shows a method 200 for crowdsourced funding of a custodial account over a network according to an embodiment of the present invention (steps 210-240). In one embodiment, each of steps 210-240 may be implemented and carried out by crowdsourced funding engine 110 (in particular portfolio funding manager 120 in response to controller 115) communicating over network 105 with applications 102 on remote devices 101 accessed by users wishing to donate to a beneficiary having one or more custodial accounts.

In step 210, portfolio funding manager 120 initiates communication with application 102. This initiation may be in response to a user opening application 102. For example, a user may open application 102 on a remote computing device. A message is then sent from the application 102 to crowdsourced funding engine 110 to initiate operation. Portfolio funding manager 120 then sends a response to application 102 to initiate communication with application 102. For example, portfolio funding manager 120 may send data enabling the display of one or more display views relating to an account of a user.

In step 220, portfolio funding manager 120 enables a user to select a funding amount. For example, portfolio funding manager 120 may output data to enable application 102 to display a display view having a user interface element which allows a user to select a funding amount. For example, the user interface element may be a template, drop down menu, text box, slider, or other input to allow a user to select a funding amount.

In step 230, portfolio funding manager 120 distributes the selected funding amount among the one or more custodial accounts of the beneficiary in respective transactions. In one example, portfolio funding manager 120 calculates the number of custodial accounts of a beneficiary and divides the selected funding amount among the custodial accounts in respective amount portions. Portfolio funding manager 120 then outputs control signals to initiate transactions to deposit payments of the amount portions into respective custodial accounts.

In one embodiment, portfolio funding manager 120 divides the selected funding amount equally among the custodial accounts in respective amount portions. In another embodiment, portfolio funding manager 120 determines whether a custodial account for college savings has reached a maximum limit according to predetermined rules, and allocates the selected funding amount up to the maximum limit for the custodial account for college savings before distributing amount portions to other accounts. In other embodiments, portfolio funding manager 120 allocates the selected funding amount among the one or more custodial accounts according to predetermined critera including criteria giving priority to one or more custodial accounts for college savings up to maximum limits according to predetermined rules, and allocates remaining portions of the selected funding amount to other custodial accounts relating to one or more of life insurance, savings, UMTA, donor advised fund, or an IRA. These embodiments are illustrative. Other allocations may be done as would be apparent to person skilled in the art given this description.

In step 240, portfolio funding manager 120 may generates one or more documents or messages associated with the respective transactions carried out in response to step 230. For example, documents or messages may be generated and sent to a user identifying information such as the funding amount selected, allocations made among custodial accounts, and other identifying information desirable to comply with rules or other requirements. Portfolio funding manager 120 may communicate with one or more services 130 to further obtain and generate appropriate documents or messages relating to the respective transactions carried out in step 230.

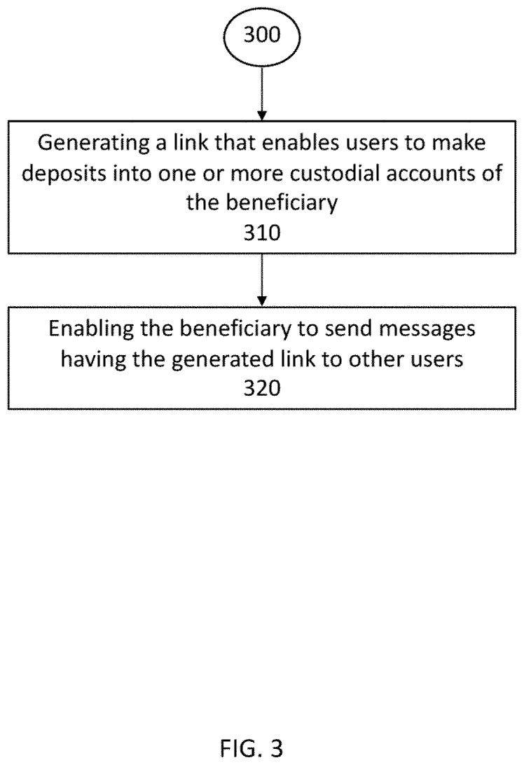

In a further feature shareable links may be used. These links further facilitate online crowdsourcing of contributions from users to custodial accounts of a beneficiary. FIG. 3 shows a method 300 for shareable link generation according to an embodiment of the present invention (steps 310-320). In step 310, portfolio funding manager 120 generates a link that enables users to make deposits into one or more custodial accounts of the beneficiary. This link may be for example a hyperlink or other identifier that enables an application to automatically make deposits into one or more custodial accounts of the beneficiary. In step 320, portfolio funding manager 120 outputs messages having the generated link to other users. For example, portfolio funding manager 120 may output text messages, social media posts, electronic mail (email) messages, notifications, or other types of electronic communication with the generated link to the other users. In this way, the other users may receive the generated messages and use the generated links to navigate to make a contribution to custodial accounts of the beneficiary.

For example, a second user may selected the generated link received in a message and open an application 102. Portfolio funding manager 120 then automatically outputs data to enable the application 102 to display one or more display views. The one or more display views enable the second user to select a funding amount (such as a deposit amount). The display views may also enable the user to choose a funding method and enter a deposit amount.

### Example Display Views

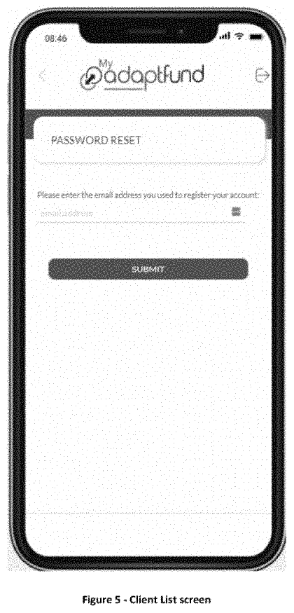

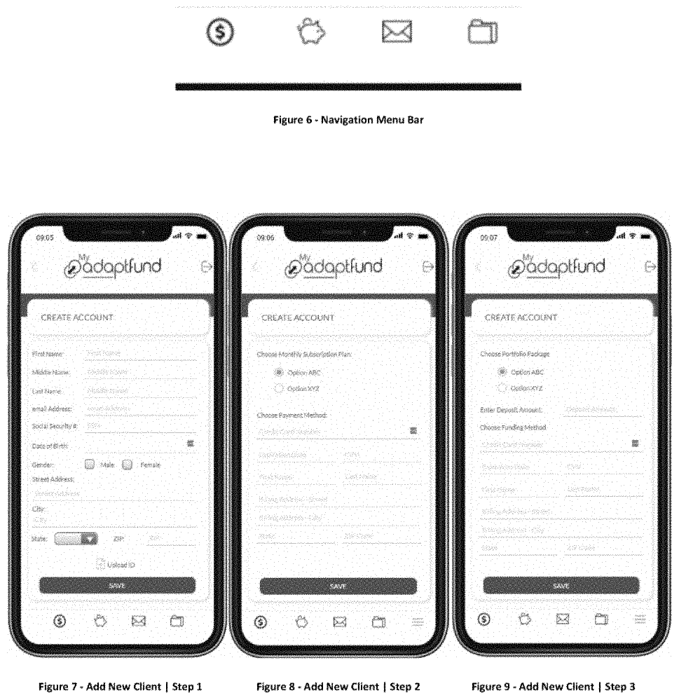

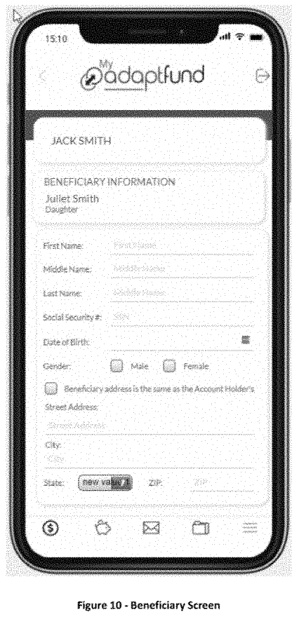

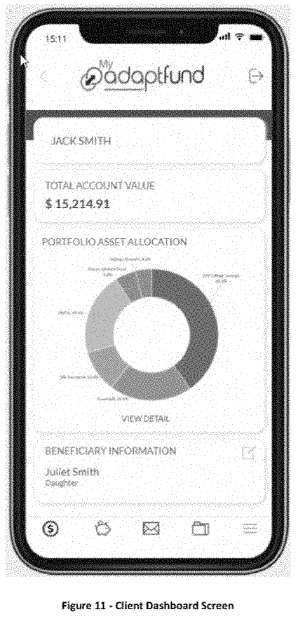

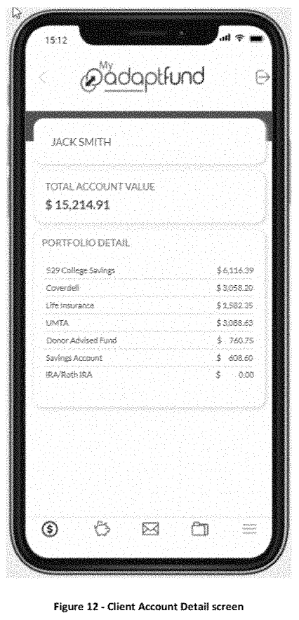

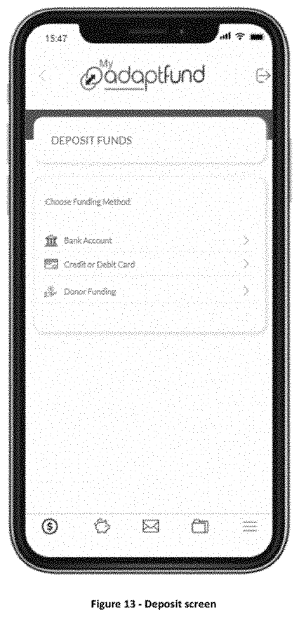

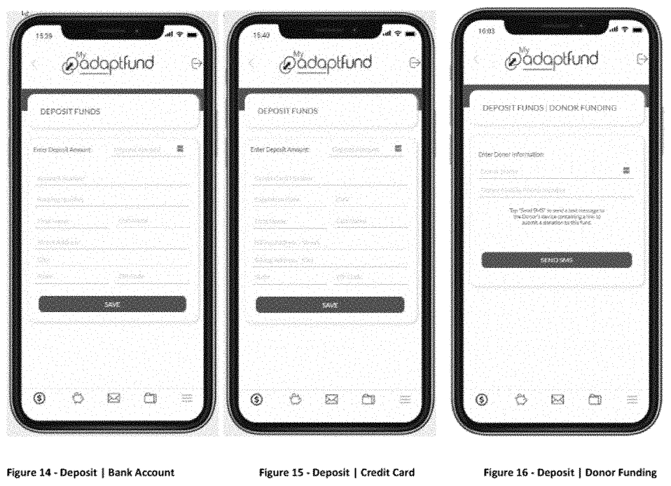

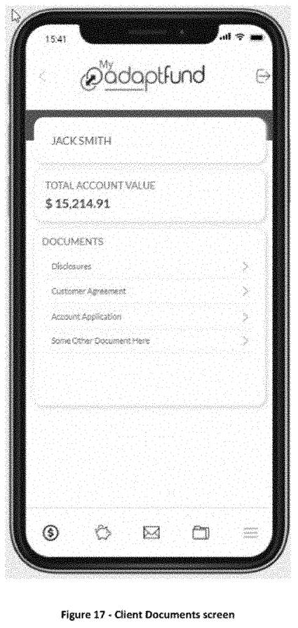

FIGS. 4-17 are images of example display views that may appear in applications 102 on display screens of mobile computing devices 101. The display views may include a log in screen (FIG. 4), a client list screen (FIG. 5), and navigation menu bar (FIG. 6). Display views may enable a user to create an account for a new client (FIG. 7), choose a payment method (FIG. 8), and choose a portfolio, deposit amount and funding method (FIG. 9). Other display views that may be output are a beneficiary display view (FIG. 10), client dashboard screen (FIG. 11), client account detail screen (FIG. 12), and deposit screen with choice of funding methods (FIG. 13). Still further display views that may be output on application 102 are display views allowing deposit through a bank account (FIG. 14), deposit through a credit card account (FIG. 15), and donor funding (FIG. 16). Finally, a display view enabling a user to view and select documents (such as disclosures, customer agreement, account application, or other documents) may be provided (FIG. 17).

In one embodiment, a log in screen as shown in FIG. 4 may include user-interface elements to enable a user to enter log in credentials (such as email address or password) to access an existing account or to allow a user to create an account). A client list screen may display a client account information once login credentials are verified.

A navigation menu bar (FIG. 6) may have different user-interface elements such as a selectable icons to allow a user (client) to view portfolio amount and contents information, amount in savings, messages, or documents. Display views may enable a user to create an account for a new client (FIG. 7), choose a payment method (FIG. 8), and choose a portfolio, deposit amount and funding method (FIG. 9).

Other display views that may be output are a beneficiary display view (FIG. 10), client dashboard screen (FIG. 11), client account detail screen (FIG. 12), and deposit screen with choice of funding methods (FIG. 13). A beneficiary display view (FIG. 10) may include name of donor (account holder) and beneficiary information (done information to whom the account holder donor is making a donation or fund contribution) such as done name, relationship to donor, full name and address of donee, social security number, date of birth and gender. These are illustrative and not intended to be limiting and may be implemented in configurations adhering to any user privacy or data use consents or terms.

As shown in FIG. 11 example, a client dashboard screen may show a donor account holder portfolio and asset allocation information in text or graphical chart summary form. A client account detail screen (FIG. 12) may include account detail information such as total account value and a listing of assets in different accounts (e.g., one or more accounts such as college savings accounts, life insurance, UMTA or trust accounts, or retirement accounts). A deposit screen (FIG. 13) may show a choice of funding methods (e.g, checking, credit/debit card payment, or other donor funding) to remit funds for a crowdsourced donation to a donee. In response to a donor selection a display view allowing deposit through a bank account (FIG. 14), deposit through a credit card account (FIG. 15), and donor funding (FIG. 16) is provided. Finally, a display view enabling a user to view and select documents (such as disclosures, customer agreement, account application, or other documents) may be provided (FIG. 17).

In another embodiment, an API may also be included which is coupled to engine 130 and communicates between application 102 and engine 130. This API can used with an existing interface hosted by a server supporting a client application 102 and by communicating with crowdsource funding engine 130 can deliver crowdsourced funding operation described herein to a client application hosted by the server.

System 100 provides a number of technical advantages. Crowdsourced funding engine 110 enables remote donors to electronically fund a donee beneficiary account over a network through applications 102 on devices 101. This omits or reduces network traffic and the number of computer terminals required by third-party brokers or financial institutions. System 100 can also scale to a larger number of devices 101 and applications 102 without having to increase network communication equipment and computer terminals required by third-party brokers or financial institutions for end users. Donors can access crowdsource funding engine 110 directly from their own devices 101 to make a donation without having to use technical equipment of a third-party broker or financial institution to initiate a donation.

### Further Examples and Advantages

In further example, application 102 may be a mobile device application (such as a downloaded stand alone application) or a web application operated on a browser of a computing device that offers its clients an ability to easily and seamlessly setup and manage a fund comprised of a pool of predefined investment vehicles, for the benefit of their minors. Application 102 supports a crowdfunding feature, which will allow other invited users (such as the client's friends and family) to contribute to the fund throughout its life, up to maturity and subsequent transfer to the beneficiary at majority. In this way, application 102 can be a consumer-friendly, easy-to-use product that seamlessly creates accounts and documentation involved in a fund's portfolio via an aggregation of API integrations, whilst concurrently increasing efficiency and reducing the labor cost involved in the manual preparation of all necessary documentation by a financial advisor. In a further advantage, the crowdfunding feature of application 102 increases adoption.

Functions of application 102 may include registration (sign up) and login/authentication and profile management including setting the following:

a. Beneficiary information

b. Funding/payment information

c. Monthly subscription plan selection

d. ID scan upload

c. Seamless account/fund setup

d. View and e-signature of all relevant documents

e. View dashboard of current accounts

f. View account status and details

g. Add funds

h. View documents

j. Send donation link to friends and family

k. Crowdfunding Receive donation link via SMS to install app and submit funding amount

1. Automatic transfers at age threshold with notifications to Assigned Advisor, Parent/Custodian, and Beneficiary

In one example, application 102 may used by the following user groups:

a. Parent/Custodians that are planning on starting a family or already have children, and wish to setup a fund for their children or minor dependents.

b. Donors such as friends and/or family of custodians, for purpose of being able to easily contribute to a beneficiary's fund.

c. Children/Minors who may be the Beneficiaries can use the application 102 to view the status of their fund.

In one implementation, application 102 (and crowdsourced funding engine 110) may integrate with Docupace (or similar secure document workflow processor provider) and a third party FinTech data aggregator/API provider such as Yodlee as part of services 130. An application may be dependent on two-way API data with the following (via Yodlee or similar service):

a) Federal AML (Finra.org)

b) SEC/FINRA and IRS Taxation regulations

c) Custodian/Payment Processor (NFS, Pershing, TD Ameritrade, Fidelity/Schwab).

### Further Embodiments

Aspects of the embodiments of system 100 including engine 110 (and its components controller 115 and portfolio funding manager 120) and application 102 may be implemented electronically using hardware, software modules, firmware, tangible computer readable or computer usable storage media having instructions stored thereon, or a combination thereof and may be implemented in one or more computer systems or other processing systems.

Embodiments may be directed to computer products comprising software stored on any computer usable medium. Such software, when executed in one or more data processing device (also called a computing device), causes a data processing device(s) to operate as described herein.

Various embodiments can be implemented, for example, using one or more computing devices. A computing device can be any type of device having one or more processors and memory. For example, a computing device can be a workstation, mobile device (e.g., a mobile phone, personal digital assistant, tablet or laptop), computer, server, computer cluster, server farm, game console, set-top box, kiosk, embedded system, or other device having at least one processor and memory.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The breadth and scope of the present invention should not be limited by any of the above-described exemplary embodiments.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A crowdsourced funding system configured to communicate over a network with applications on remote devices accessed by users wishing to donate to a beneficiary having one or more custodial accounts comprising:
a controller; and
a portfolio funding manager coupled to the controller and implemented on one or more processors, wherein portfolio funding manager is configured to:
enable a user to select a funding amount,
distribute the selected funding amount among the one or more custodial accounts of the beneficiary in respective transactions, and
generate one or more documents or messages associated with the respective transactions.

2. The system of claim 1, wherein the portfolio funding manager is further configured to:
generate a link that enables users to make deposits into one or more custodial accounts of the beneficiary; and
enable the beneficiary to send messages having the generated link to other users.

3. The system of claim 2, wherein the other users comprise friends and family of the beneficiary.

4. The system of claim 1, wherein the portfolio funding manager enables the user to select a funding amount including outputting one or more display views that enable the user to choose a funding method and enter a deposit amount.

5. The system of claim 2, wherein the portfolio funding manager is further configured to communicate with a second user in response to the second user having selected the generated link.

6. The system of claim 5, wherein the portfolio funding manager enables the second user to select a funding amount including outputting one or more display views that enable the second user to enter a deposit amount.

7. The system of claim 1, wherein the portfolio funding manager is further configured to output one or more display views to the user including one or more of the following display views: a dashboard view, a view of account detail, a view that enables addition of funds, a view that enables viewing of documents, a view that enables management of a user profile, a view to enable contact with a financial advisor, and a view that enables a donation link to be sent to friends and family.

8. The system of claim 1, wherein the portfolio funding manager is further configured to determine whether a custodial account for college savings has reached a maximum limit according to predetermined rules, and to allocate the selected funding amount up to the maximum limit for the custodial account for college savings.

9. The system of claim 1, wherein the portfolio funding manager is further configured to allocate the selected funding amount among the one or more custodial accounts according to predetermined critera including criteria giving priority to one or more custodial accounts for college savings up to maximum limits according to predetermined rules, and allocating remaining portions of the selected funding amount to other custodial accounts relating to one or more of life insurance, savings, UMTA, donor advised fund, or an IRA.

10. The system of claim 1, wherein the portfolio funding manager is further configured to generate documents for disclosure or signature according to predetermined rules.

11. The system of claim 1, wherein the portfolio funding manager is further configured to evaluate the selected funding amount according to predetermined rules.

12. A computer-implemented method for crowdsourced funding over a network with applications on remote devices accessed by users wishing to donate to a beneficiary having one or more custodial accounts comprising:
enabling a user to select a funding amount;
distributing the selected funding amount among the one or more custodial accounts of the beneficiary in respective transactions; and
generating one or more documents or messages associated with the respective transactions.

13. The computer-implemented method of claim 12, further comprising:
generating a link that enables users to make deposits into one or more custodial accounts of the beneficiary; and
enabling the beneficiary to send messages having the generated link to other users.

13. The computer-implemented method of claim 12, wherein the enabling the user to select a funding amount includes outputting one or more display views that enable the user to choose a funding method and enter a deposit amount.

14. The computer-implemented method of claim 13, further comprising communicating with a second user in response to the second user having selected the generated link.

15. The computer-implemented method of claim 14, further comprising enabling the second user to select a funding amount including outputting one or more display views that enable the second user to enter a deposit amount.

16. The computer-implemented method of claim 12, further comprising outputting one or more display views to the user including one or more of the following display views: a dashboard view, a view of account detail, a view that enables addition of funds, a view that enables viewing of documents, a view that enables management of a user profile, a view to enable contact with a financial advisor, and a view that enables a donation link to be sent to friends and family.

17. The computer-implemented method of claim 12, further comprising:
determining whether a custodial account for college savings has reached a maximum limit according to predetermined rules; and
allocating the selected funding amount up to the maximum limit for the custodial account for college savings.

18. The computer-implemented method of claim 12, further comprising:
allocating the selected funding amount among the one or more custodial accounts according to predetermined critera including criteria giving priority to one or more custodial accounts for college savings up to maximum limits according to predetermined rules; and
allocating remaining portions of the selected funding amount to other custodial accounts relating to one or more of life insurance, savings, UMTA, donor advised fund, or an IRA.

19. The computer-implemented method of claim 12, further comprising generating documents for disclosure or signature according to predetermined rules.

20. The computer-implemented method of claim 12, further comprising evaluating the selected funding amount according to predetermined rules.

21. A non-transitory computer-readable storage device having instructions stored thereon that, when executed by at least one processor, causes the at least one processor to perform operations for crowdsourced funding over a network with applications on remote devices accessed by users wishing to donate to a beneficiary having one or more custodial accounts, wherein the operations comprise:
enabling a user to select a funding amount;
distributing the selected funding amount among the one or more custodial accounts of the beneficiary in respective transactions;
generating one or more documents or messages associated with the respective transactions;
generating a link that enables users to make deposits into one or more custodial accounts of the beneficiary; and
enabling the beneficiary to send messages having the generated link to other users.
